(19) United States
(12) Patent Application Publication
(10) Pub. No.: US 2017/0345399 A1
(43) Pub. Date: Nov. 30, 2017

(54) METHOD FOR PERFORMING DISPLAY CONTROL OF AN ELECTRONIC DEVICE IN RESPONSE TO A USER ACTIVITY, AND ASSOCIATED APPARATUS

(71) Applicant: MEDIATEK INC., Hsin-Chu (TW)

(72) Inventors: Yi-Kai Lee, New Taipei City (TW); Chun-Chia Chen, Hsinchu City (TW)

(21) Appl. No.: 15/168,248

(22) Filed: May 31, 2016

(51) Int. Cl. G09G 5/38; G06F 3/0346; G06F 3/03; G09G 5/373; G06F 3/01

(52) U.S. Cl. CPC G09G 5/38; G09G 5/373; G06F 3/017; G06F 3/0304; G06F 3/013; G06F 3/0346; G09G 2320/0626; G09G 2320/068; G09G 2320/0686

(57) ABSTRACT

A method for performing display control of an electronic device and an associated apparatus are provided, where the method may include: detecting a user activity of a user to determine a user orientation of the user with respect to a display area of the electronic device; and according to the user orientation of the user with respect to the display area, selectively adjusting at least one portion of a plurality of display contents in the display area to emulate what is viewed from a normal direction of the display area, to allow the user to view the at least one portion of the plurality of display contents without need of changing a display area orientation of the display area.

### BACKGROUND

The present invention relates to display adjustment allowing a user to have improved viewing experience, and more particularly, to a method for performing display control of an electronic device, and an associated apparatus.

According to the related art, a conventional electronic device that is equipped with a display module, such as a conventional multifunctional mobile phone, may be designed to display images on the display module. However, some problems may occur. For example, when the conventional electronic device is placed far from a user, an image displayed on the display module may seem to have been squeezed. In another example, when the conventional electronic device is put on a desk and is positioned at the center of the desk, between two users who are sitting at different sides of the desk, respectively, one of the two users may easily read an image having some texts that is displayed on the display module, but the other of the two users may not easily read these texts of the image on the display module. Thus, a novel method and a corresponding architecture are required to improve the viewing experience of the users.

### SUMMARY

It is an objective of the claimed invention to provide a method for performing display control of an electronic device, and an associated apparatus, in order to solve the above-mentioned problems.

It is another objective of the claimed invention to provide a method for performing display control of an electronic device, and an associated apparatus, in order to enhance viewing experience of a user in each of various situations.

According to at least one preferred embodiment, a method for performing display control of an electronic device is provided, where the method may comprise the steps of: detecting a user activity of a user to determine a user orientation of the user with respect to a display area of the electronic device; and according to the user orientation of the user with respect to the display area, selectively adjusting at least one portion of a plurality of display contents in the display area to emulate what is viewed from a normal direction of the display area, to allow the user to view the at least one portion of the plurality of display contents without need of changing a display area orientation of the display area.

According to at least one preferred embodiment, an apparatus for performing display control of an electronic device is provided, where the apparatus may comprise at least one portion (e.g. a portion or all) of an electronic device. For example, the apparatus may comprise a processing circuit that is positioned in the electronic device, and the processing circuit may comprise a detection module and an adjustment module. The detection module may be arranged for detecting a user activity of a user to determine a user orientation of the user with respect to a display area of the electronic device. In addition, according to the user orientation of the user with respect to the display area, the adjustment module may selectively adjust at least one portion of a plurality of display contents in the display area to emulate what is viewed from a normal direction of the display area, to allow the user to view the at least one portion of the plurality of display contents without need of changing a display area orientation of the display area.

It is an advantage of the present invention that the present invention method and apparatus can enhance viewing experience of a user in each of various situations, and the related art problems will no longer be an issue.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for performing display control of an electronic device according to an embodiment of the present invention.

FIG. 2 illustrates a flowchart of a method for performing display control of an electronic device according to an embodiment of the present invention.

FIG. 3 illustrates the adjustment applied to a video object on an image and involved with the method shown in FIG. 2 according to an embodiment of the present invention.

FIG. 4 illustrates a predetermined shape of space involved with the method shown in FIG. 2 according to an embodiment of the present invention.

FIG. 5 illustrates the adjustment applied to a two-dimensional (2D) image and involved with the method shown in FIG. 2 according to an embodiment of the present invention.

FIG. 6 illustrates the adjustment applied to the 2D image and involved with the method shown in FIG. 2 according to another embodiment of the present invention.

FIG. 7 illustrates the adjustment applied to the 2D image and involved with the method shown in FIG. 2 according to another embodiment of the present invention.

FIG. 8 illustrates the adjustment applied to the 2D image and involved with the method shown in FIG. 2 according to another embodiment of the present invention.

FIG. 9 illustrates a multi-user control scheme involved with the method shown in FIG. 2 according to an embodiment of the present invention.

FIG. 10 illustrates a multi-device control scheme involved with the method shown in FIG. 2 according to an embodiment of the present invention.

FIG. 11 illustrates a wearable device control scheme involved with the method shown in FIG. 2 according to an embodiment of the present invention.

FIG. 12 illustrates a left configuration of a majority group control scheme involved with the method shown in FIG. 2 according to an embodiment of the present invention.

FIG. 13 illustrates a normal configuration of the majority group control scheme involved with the method shown in FIG. 2 according to an embodiment of the present invention.

FIG. 14 illustrates a right configuration of the majority group control scheme involved with the method shown in FIG. 2 according to an embodiment of the present invention.

FIG. 15 illustrates a first configuration of a dynamic control scheme involved with the method shown in FIG. 2 according to an embodiment of the present invention.

FIG. 16 illustrates a second configuration of the dynamic control scheme involved with the method shown in FIG. 2 according to an embodiment of the present invention.

FIG. 17 illustrates a flexible display control scheme involved with the method shown in FIG. 2 according to an embodiment of the present invention.

FIG. 18 illustrates a flexible display control scheme involved with the method shown in FIG. 2 according to another embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

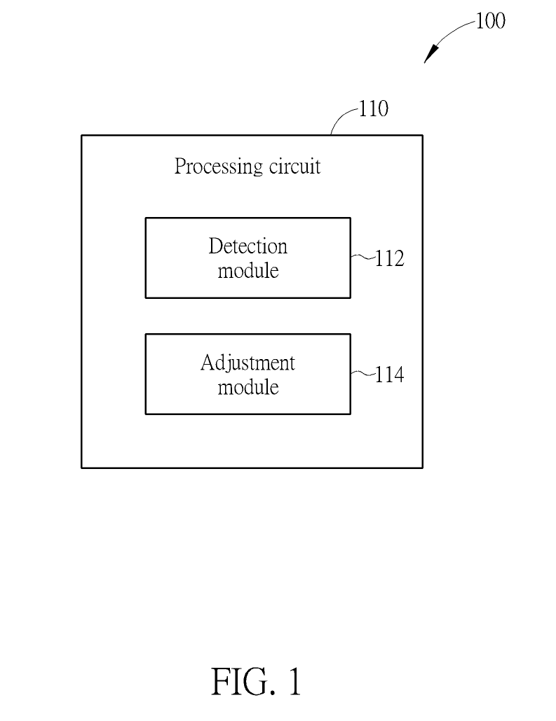

FIG. 1 is a diagram of an apparatus 100 for performing display control of an electronic device according to an embodiment of the present invention, where the apparatus 100 may comprise at least one portion (e.g. a portion or all) of the electronic device. For example, the apparatus 100 may comprise a portion of the electronic device mentioned above, and more particularly, can be at least one hardware circuit such as at least one integrated circuit (IC) within the electronic device and associated circuits thereof. In another example, the apparatus 100 can be the whole of the electronic device mentioned above. In another example, the apparatus 100 may comprise a system comprising the electronic device mentioned above (e.g. a wireless communications system comprising the electronic device). Examples of the electronic device may include, but not limited to, a mobile phone (e.g. a multifunctional mobile phone), a tablet, a personal computer such as a laptop computer or a desktop computer, a wearable device and an Internet of Things (IoT) device.

As shown in FIG. 1, the apparatus 100 may comprise a processing circuit 110 that is positioned in the electronic device, and the processing circuit 110 may comprise a detection module 112 and an adjustment module 114. The detection module 112 may be arranged for performing detection on at least one user of the electronic device (e.g. one or more users of the electronic device) to generate at least one detection result (e.g. one or more detection results), and the adjustment module 114 may be arranged for determining whether to adjust displayed video information or determining the adjustment to be applied to the displayed video information according to the aforementioned at least one detection result, to enhance viewing experience of the user. For example, the processing circuit 110 may be implemented with at least one processor (e.g. one or more processors) running program codes to carry out the associated operations of the detection module 112 and the adjustment module 114, where the detection module 112 and the adjustment module 114 may be implemented with program modules that may comprise at least one portion (e.g. a portion or all) of the program codes. This is for illustrative purposes only, and is not meant to be a limitation of the present invention. According to some embodiments of the present invention, the detection module 112 and/or the adjustment module 114 (e.g. one or both of the detection module 112 and the adjustment module 114) may be implemented with hardware circuits such as customized circuits. For example, these customized circuits may be positioned within the aforementioned at least one IC. According to another embodiment of the present invention, the detection module 112 and/or the adjustment module 114 may be implemented with firmware.

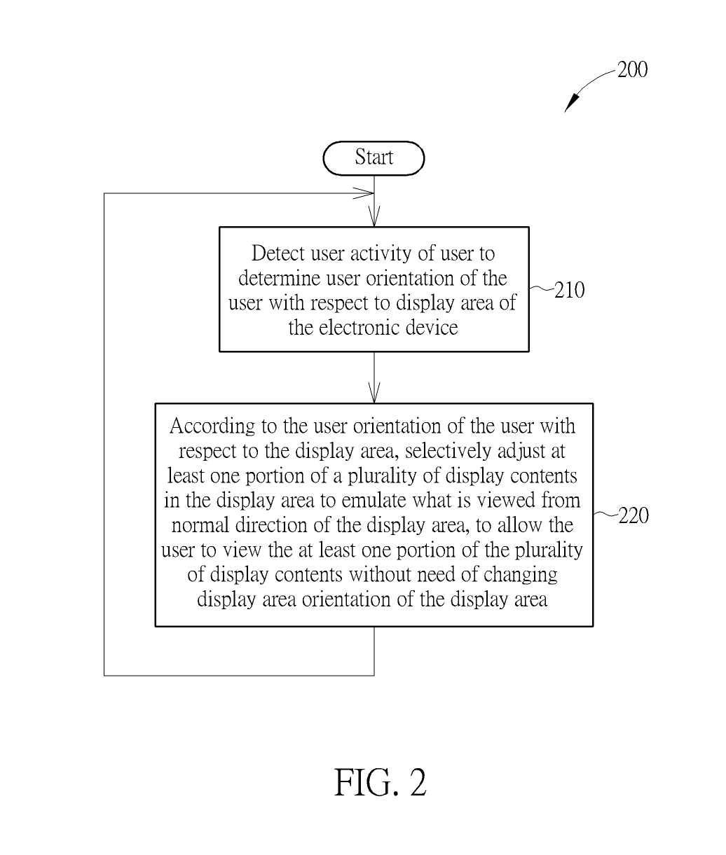

FIG. 2 illustrates a flowchart of a method 200 for performing display control of an electronic device according to an embodiment of the present invention. The method 200 shown in FIG. 2 can be applied to the apparatus 100 shown in FIG. 1, and can be applied to the processing circuit 110 (e.g. the aforementioned at least one processor and some program modules running thereon). For example, the program modules may be provided through a computer program product having program instructions for instructing the aforementioned at least one processor to perform the method 200 shown in FIG. 2, where the computer program product may be implemented as a non-transitory computer-readable medium (e.g. a floppy disk or a compact disc-read only memory (CD-ROM)) storing the program instructions or an equivalent version thereof, such as a software package for being installed. This is for illustrative purposes only, and is not meant to be a limitation of the present invention. The method can be described as follows.

In Step 210, the processing circuit 110 (more particularly, the detection module 112) may detect a user activity of a user to determine a user orientation of the user with respect to a display area of the electronic device. For example, the user may stay still or may move around within a predetermined shape of space in front of the display area (e.g. a cone in front of the display area, where the apex thereof may be located at the center of the display area), and the user orientation of the user with respect to the display area may be zero or a few degrees deviated from a z-axis of the display area (e.g. the z-axis may be perpendicular to the display area and may pass through the center of the display area, where the display area may be on the coordinate plane of the associated x-axis and y-axis). In another example, the user may move toward one side of the display area or move outside the predetermined shape of space (e.g. the cone in front of the display area), and the user orientation of the user with respect to the display area may be several tens of degrees deviated from the z-axis of the display area.

In Step 220, according to the user orientation of the user with respect to the display area, the processing circuit 110 (more particularly, the adjustment module 114) may selectively adjust at least one portion (e.g. one or more portions) of a plurality of display contents in the display area to emulate what is viewed from a normal direction of the display area, such as a direction along a virtual line perpendicular to the display area (e.g. the z-axis mentioned above), to allow the user to view the at least one portion or the whole of the plurality of display contents without need of changing a display area orientation of the display area. For example, in a situation where the user stays still or moves around within the predetermined shape of space (e.g. the cone in front of the display area), as the user orientation of the user with respect to the display area may be zero or a few degrees deviated from the z-axis of the display area, the processing circuit 110 (more particularly, the adjustment module 114) may prevent adjusting the aforementioned at least one portion of the plurality of display contents, so the aforementioned at least one portion of the plurality of display contents may be displayed as usual. In another example, in a situation where the user moves toward one side of the display area or moves outside the predetermined shape of space (e.g. the cone in front of the display area), as the user orientation of the user with respect to the display area may be several tens of degrees deviated from the z-axis of the display area, the processing circuit 110 (more particularly, the adjustment module 114) may adjust the aforementioned at least one portion of the plurality of display contents, so the aforementioned at least one portion of the plurality of display contents may be adjusted to enhance viewing experience of the user.

As shown in FIG. 2, after the operation of Step 220 is performed, Step 210 may be re-entered. For example, when Step 210 is re-entered, the operation of Step 210 may be performed for detecting the latest condition such as the latest user orientation of the user with respect to the display area, and the operation of Step 220 may be performed in response to the latest condition mentioned above. This is for illustrative purposes only, and is not meant to be a limitation of the present invention. According to some embodiments, one or more other users may exist. In addition, when Step 210 is re-entered, the operation of Step 210 may be performed for detecting the latest condition such as the latest user orientation of any of the other user(s) with respect to the display area, and the operation of Step 220 may be performed in response to the latest condition mentioned above.

According to some embodiments, in Step 210, the processing circuit 110 (more particularly, the detection module 112) may detect at least one face image (e.g. one or more face images) of the user to determine the user orientation of the user with respect to the display area of the electronic device, where the aforementioned at least one face image may indicate the user activity. For example, the processing circuit 110 (more particularly, the detection module 112) may perform face recognition on the face image(s) of the user to determine a face orientation of the user with respect to the center point of the display area, and may determine the user orientation of the user with respect to the display area according to the face orientation with respect to the center point of the display area. Suppose that the electronic device is put on a desk and is far from the user, and that the user may find that an image comprising the at least one portion of the plurality of display contents mentioned in Step 220 may seem to have been squeezed before the operation of Step 220 is performed. After the operation of Step 220 is performed, the image comprising the at least one portion of the plurality of display contents may have been adjusted so that the user may view the adjusted image easily and clearly, and the user may find nothing in the adjusted image being squeezed, as if the display module had been rotated to make the normal vector of the display area mentioned in Step 210 (e.g. the normal vector of a portion or all of a display region of the display module) be directed to the eyes of the user. This is for illustrative purposes only, and is not meant to be a limitation of the present invention. According to some embodiments, in Step 210, the processing circuit 110 (more particularly, the detection module 112) may perform infrared (IR) detection on the user to determine the user orientation of the user with respect to the display area of the electronic device, whereat least one IR detection result (e.g. one or more IR detection results) of the IR detection may indicate the user activity. According to some embodiments, in Step 210, the processing circuit 110 (more particularly, the detection module 112) may perform acoustic detection on the user to determine the user orientation of the user with respect to the display area of the electronic device, whereat least one acoustic detection result (e.g. one or more acoustic detection results) of the acoustic detection may indicate the user activity. According to some embodiments, in Step 210, the processing circuit 110 (more particularly, the detection module 112) may perform location detection on the user according to location information of a portable or wearable device of the user, such as the location information determined according to Global Positioning System (GPS), Bluetooth (BT), or Wireless-Fidelity (Wi-Fi) technologies, to determine the user orientation of the user with respect to the display area of the electronic device, where at least one location detection result (e.g. one or more location detection results) of the location detection may indicate the user activity. Examples of the portable or wearable device of the user may include, but not limited to, smart phones, necklaces, earrings, earphones, glasses, and watches.

According to some embodiments, in Step 220, the processing circuit 110 (more particularly, the adjustment module 114) may expand the aforementioned at least one portion of the plurality of display contents. For example, the expanded portion(s) of the plurality of display contents may be displayed on some partial regions of the display region on the display module that are farther from the user than other partial regions of the display region. This is for illustrative purposes only, and is not meant to be a limitation of the present invention. According to some embodiments, the aforementioned at least one portion of the plurality of display contents may comprise different portions of the plurality of display contents, and, in Step 220, the processing circuit 110 (more particularly, the adjustment module 114) may scale up or down the portions of the plurality of display contents with different size-adjustment ratios, respectively. For example, a first portion within the portions of the plurality of display contents may be closer to the user than a second portion within the portions of the plurality of display contents, and a first size-adjustment ratio corresponding to the first portion may be less than a second size-adjustment ratio corresponding to the second portion.

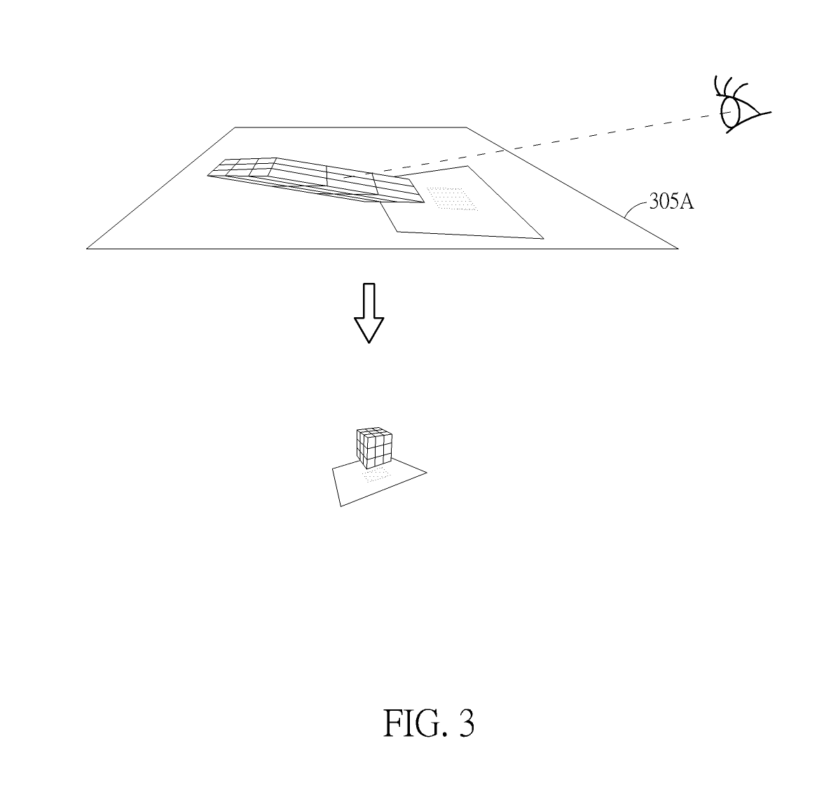

FIG. 3 illustrates the adjustment applied to a video object on an image and involved with the method 200 shown in FIG. 2 according to an embodiment of the present invention. For example, the processing circuit 110 may perform face recognition on one or more face images (e.g. the face image(s) mentioned in some embodiments described above) to determine whether the one or more face images belong to the user mentioned in Step 210, such as an authorized user of the electronic device. As a result, the operations of Step 210 and Step 220 may be performed for a correct person such as this user.

In addition, the processing circuit 110 (more particularly, the detection module 112) may determine the user orientation of the user with respect to the display area by using one or more of various types of detection such as that in some embodiments described above (e.g. the face image detection, the IR detection, the acoustic detection, and the location detection). For example, the processing circuit 110 may sense the ambient light by utilizing an ambient light sensor, to determine an ambient light intensity. When the ambient light intensity is greater than or equal to a predetermined threshold, the processing circuit 110 may perform the face image detection to determine the user orientation of the user with respect to the display area. When the ambient light intensity is less than the predetermined threshold, the processing circuit 110 may perform one of the other types of detection (e.g. the IR detection, the acoustic detection, or the location detection) to determine the user orientation of the user with respect to the display area.

Suppose that the electronic device is put on the desk and is far from the user, and that the user may find that the image comprising the plurality of display contents mentioned in Step 220 may seem to have been squeezed before the operation of Step 220 is performed. As shown in the upper half of FIG. 3, in Step 220, the processing circuit 110 (more particularly, the adjustment module 114) may expand the aforementioned at least one portion of the plurality of display contents, to generate the expanded image for being displayed on the display area (e.g. the display region 305A of the display module). As a result of performing the operation of Step 220, the image comprising the plurality of display contents has been adjusted so that the user may view the adjusted image such as the expanded image easily and clearly. As shown in the lower half of FIG. 3, the user may find nothing in the adjusted image being squeezed, as if the display module had been rotated to make the normal vector of the display area mentioned in Step 210 (e.g. the normal vector of a portion or all of the display region 305A) be directed to the eyes of the user. Please note that the video objects shown in the lower half of FIG. 3 (e.g. a Rubik's Cube and a plate below it) can be taken as an example of an emulation result of the emulation involved with the operation of Step 220 (i.e. the emulation result generated by emulating what is viewed from the normal direction of the display area). For brevity, similar descriptions for this embodiment are not repeated in detail here.

In the embodiment shown in FIG. 3, expanding the aforementioned at least one portion of the plurality of display contents can be taken as an example of the adjustment of Step 220. This is for illustrative purposes only, and is not meant to be a limitation of the present invention. According to some embodiments, the adjustment of Step 220 may vary. Examples of the adjustment of Step 220 may include, but not limited to, scaling up or down the portion(s) of the plurality of display contents, rotating the portion(s) of the plurality of display contents, and brightness adjustment. For example, in the case of rotating the portion(s) of the plurality of display contents, a typical rotation angle of rotating the portion(s) of the plurality of display contents may be equal to 90 degrees, 180 degrees, or 270 degrees. According to some embodiments, in Step 220, the processing circuit 110 (more particularly, the adjustment module 114) may adjust an image orientation of a two-dimensional (2D) image within the display area (e.g. the display region 305A), where the 2D image may comprise the aforementioned at least one portion of the plurality of display contents. For example, as a result of adjusting the image orientation of the 2D image, the 2D image may be rotated to become suitable for the user to view it. In another example, in a situation where the 2D image comprise some texts therein, as a result of adjusting the image orientation of the 2D image, the 2D image may be rotated to become suitable for the user to read these texts.

In addition, in the embodiment shown in FIG. 3, adjusting the shape(s) and the size(s) of the video object(s) can be taken as an example of the adjustment of Step 220. This is for illustrative purposes only, and is not meant to be a limitation of the present invention. According to some embodiments, in Step 220, the processing circuit 110 (more particularly, the adjustment module 114) may brighten the aforementioned at least one portion of the plurality of display contents. According to some embodiments, the aforementioned at least one portion of the plurality of display contents may comprise different portions of the plurality of display contents (e.g. the different portions mentioned in some of the above embodiments), and, in Step 220, the processing circuit 110 (more particularly, the adjustment module 114) may adjust brightness of the portions of the plurality of display contents with different brightness-adjustment ratios, respectively. For example, a first portion within the portions of the plurality of display contents (e.g. the aforementioned first portion) may be closer to the user than a second portion within the portions of the plurality of display contents (e.g. the aforementioned second portion), and a first brightness-adjustment ratio corresponding to the first portion may be less than a second brightness-adjustment ratio corresponding to the second portion.

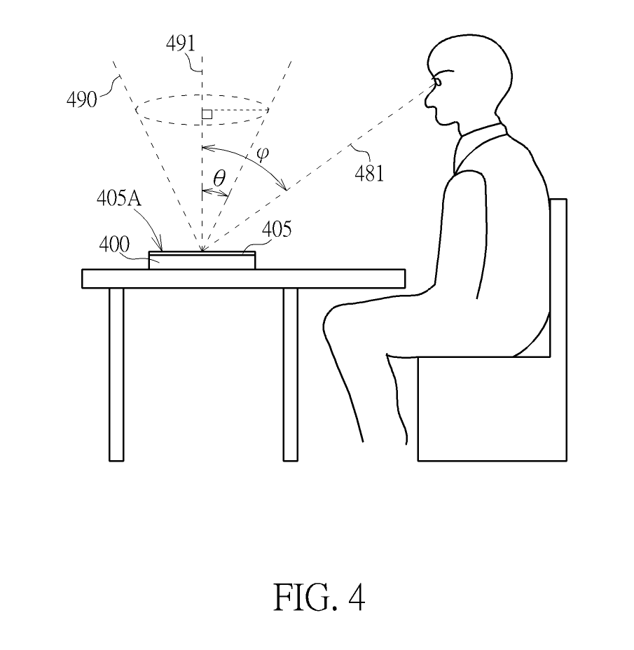

FIG. 4 illustrates the predetermined shape of space involved with the method 200 shown in FIG. 2 according to an embodiment of the present invention, where a tablet 400 can be taken as an example of the electronic device. The tablet 400 may comprise a touch-sensitive display module 405, which can be taken as an example of the display module mentioned in some embodiments described above, and the touch-sensitive display module 405 may have a display region 405A, which can be taken as an example of the display region 305A shown in FIG. 3.

As shown in FIG. 4, the predetermined shape of space in this embodiment can be a cone 490, which can be taken as an example of the cone mentioned in the embodiment shown in FIG. 2. In addition, the cone 490 can be defined by a characteristic angle θ thereof, such as the angle between any direct line on the surface of the cone 490 and the axis 491 of the cone 490. According to this embodiment, the axis 491 may be perpendicular to the display region 405A and may pass through the center point of the display region 405A, and therefore, the axis 491 of the cone 490 may be equivalent to the z-axis of the display area such as the display region 405A. Additionally, the line 481 that passes through the center point of the display region 405A and is directed toward the midpoint between the eyes of the user may indicate the face orientation of the user with respect to the center point of the display region 405A. For example, when the user orientation of the user with respect to the display area (e.g. the face orientation of the user with respect to the center point of the display region 405A) falls outside the predetermined range such as that defined by the characteristic angle θ (e.g. the angle φ may be greater than the characteristic angle θ, as shown in FIG. 4), the processing circuit 110 may trigger adjusting the aforementioned at least one portion of the plurality of display contents in the display area, such as the adjustment shown in the upper half of FIG. 3. This is for illustrative purposes only, and is not meant to be a limitation of the present invention. According to some embodiments, the user may pull the tablet 400 to make the tablet 400 become closer to the user, and therefore the angle φ may decrease. For example, when the user orientation of the user with respect to the display area (e.g. the face orientation of the user with respect to the center point of the display region 405A) falls within the predetermined range such as that defined by the characteristic angle θ (e.g. the angle φ may be less than the characteristic angle θ), the processing circuit 110 may cancel adjusting the aforementioned at least one portion of the plurality of display contents in the display area, such as the adjustment shown in the upper half of FIG. 3, then the aforementioned at least one portion of the plurality of display contents in the display area may be recovered (as if the adjustment of Step 220 had not been applied to the aforementioned at least one portion of the plurality of display contents). According to some embodiments, when the user orientation of the user with respect to the display area (e.g. the face orientation of the user with respect to the center point of the display region 405A) falls within the predetermined range such as that defined by the characteristic angle θ (e.g. the angle φ may be less than the characteristic angle θ), the processing circuit 110 may gradually reduce the adjustment of Step 220, such as the adjustment shown in the upper half of FIG. 3, then the aforementioned at least one portion of the plurality of display contents may be gradually recovered, where gradually reducing the adjustment of Step 220 may be regarded as a recovery animation of the recovery from the adjustment of Step 220.

For better comprehension, the characteristic angle θ may be equal to a predetermined angle such as 30 degrees. This is for illustrative purposes only, and is not meant to be a limitation of the present invention. According to some embodiments, the characteristic angle θ may be equal to any of other values.

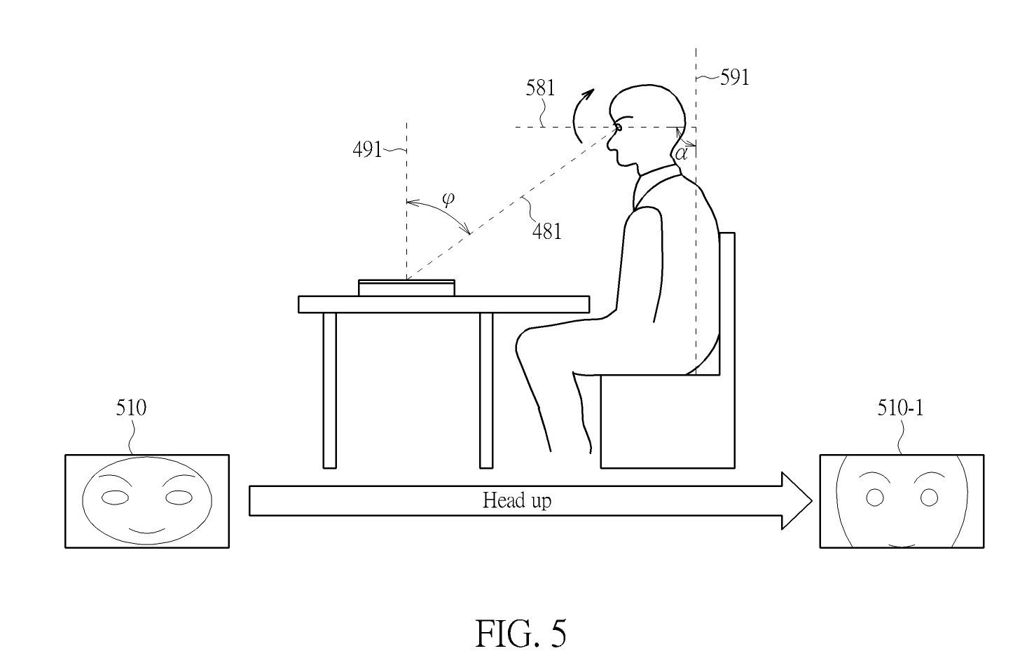

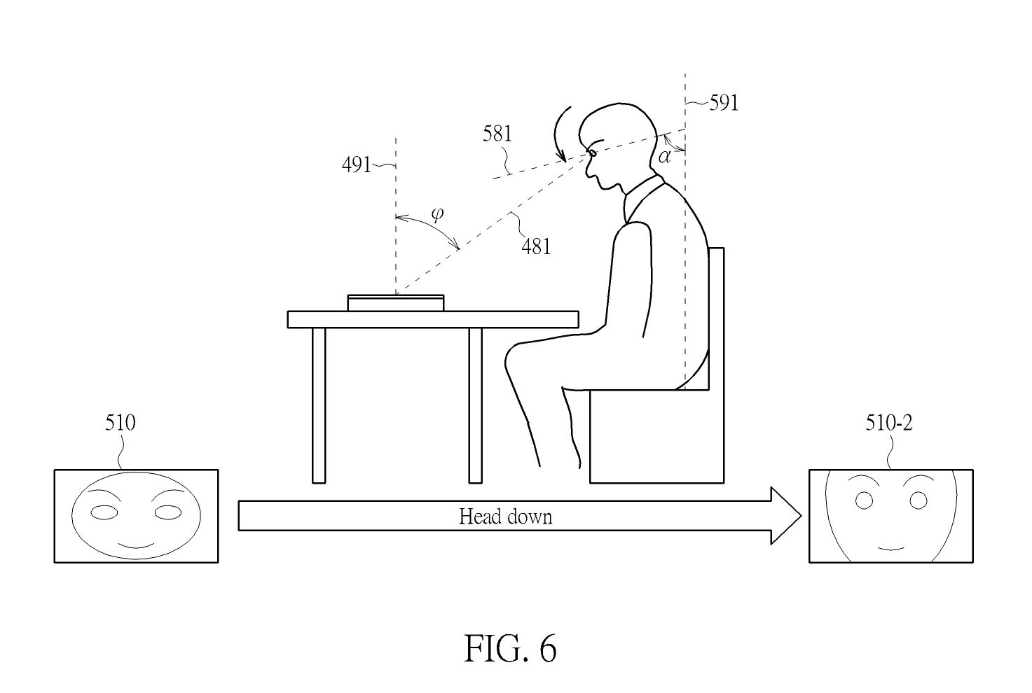

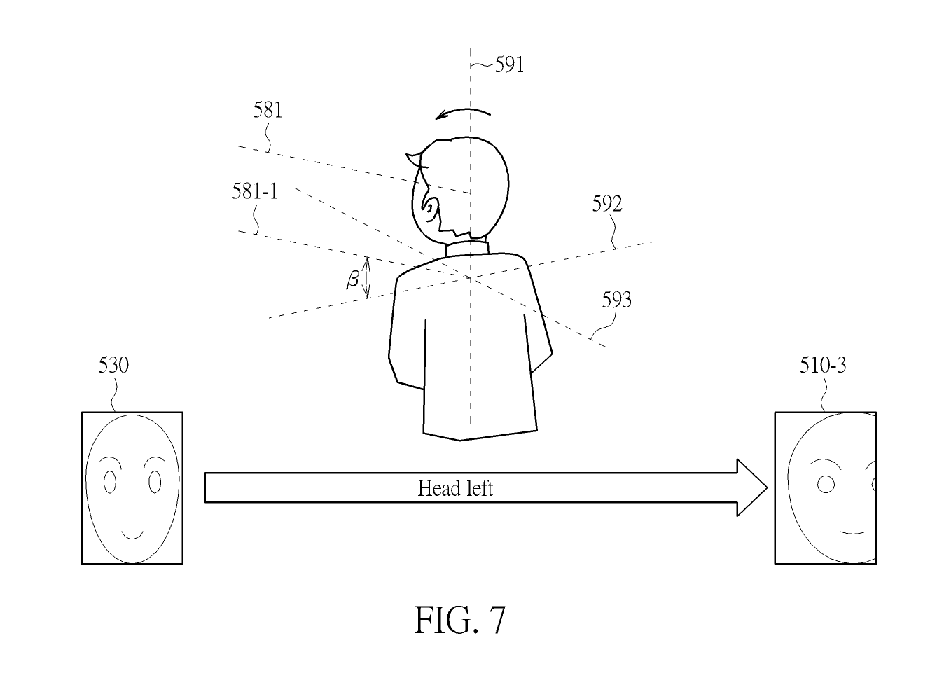

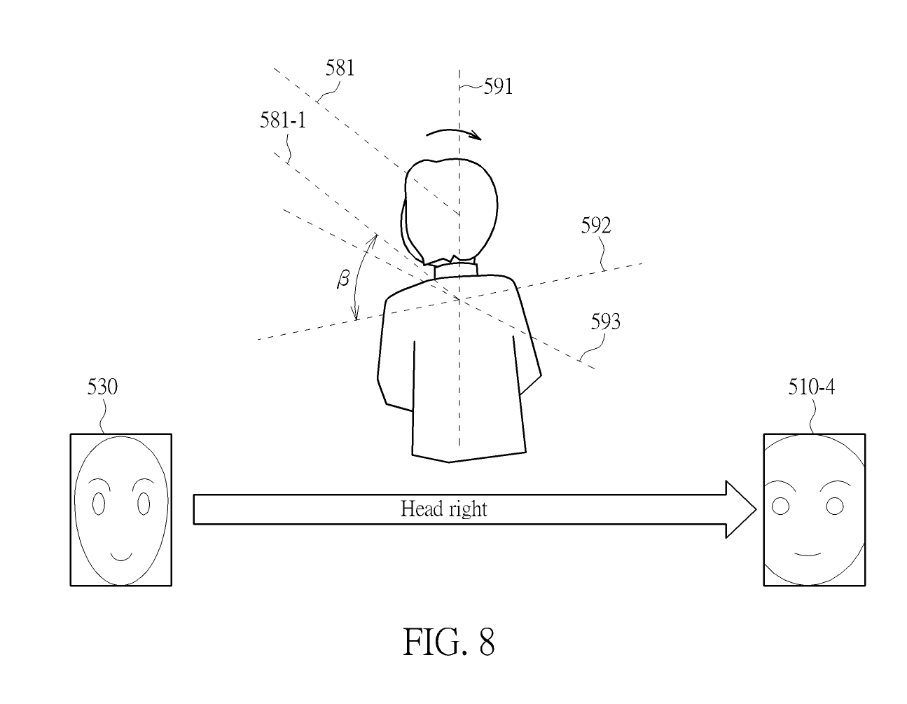

FIGS. 5-8 illustrate the adjustment applied to a 2D image and involved with the method 200 shown in FIG. 2 according to different embodiments of the present invention. For example, the user may feel that the 2D image (which may comprise a video object such as a face, for example) is a squeezed image (e.g. the squeezed image 510 shown in any of FIGS. 5-6, or the squeezed image 530 shown in any of FIGS. 7-8) in one of various situations, and each of the squeezed images 510 and 530 may indicate the viewing experience of the user before the adjustment of Step 220 is applied to the aforementioned at least one portion of the plurality of display contents. According to some embodiments such as that respectively shown in FIGS. 5-8, in Step 210, the processing circuit 110 (more particularly, the detection module 112) may detect the user activity of the user to further determine a forehead orientation of the user with respect to at least one body axis of the user, such as one or more of the three body axes 591, 592, and 593 of the user, where the line 581-1 is the projection of the line 581 on the plane of the body axes 592 and 593, and the three body axes 591, 592, and 593 may be perpendicular to each other. For example, the processing circuit 110 (more particularly, the detection module 112) may perform face recognition and body recognition to determine the forehead orientation of the user with respect to the aforementioned at least one body axis of the user, and may monitor the variation of the forehead orientation through monitoring the variation of the angle α between the line 581 and the body axis 591 and monitoring the variation of the angle β between the line 581-1 and the body axis 592. In addition, in Step 220, the processing circuit 110 (more particularly, the adjustment module 114) may adjust the 2D image within the display area, where this 2D image may comprise the aforementioned at least one portion of the plurality of display contents.

In a situation such as that the user is sitting at one side of the desk, as shown in any of FIGS. 5-6, the user may feel that the 2D image looks like the squeezed image 510 (e.g. a vertically squeezed image). In the embodiments respectively shown in FIG. 5 and FIG. 6, the forehead orientation may be indicated by the angle α between the line 581 and the body axis 591. For example, the user may move his/her head up and the angle α may increase as shown in FIG. 5, and, in Step 210, the processing circuit 110 (more particularly, the detection module 112) may detect that the user moves his/her head up. As a result, in Step 220, the processing circuit 110 (more particularly, the adjustment module 114) may adjust the 2D image by expanding at least one portion (e.g. a portion or all) of the 2D image with the associated image center being shifted downward to generate the shifted image 510-1 (with expansion) for being displayed on the display area. Please note that the shifted image 510-1 may be equivalent to the processing result of generating an expanded version of the 2D image (e.g. a vertically expanded version of the 2D image) and shifting this expanded version of the 2D image downward and further cropping a portion of this expanded version of the 2D image with a display window having the same size as that of the 2D image. As the shifted image 510-1 may be generated by expanding the at least one portion of the 2D image with the associated image center being shifted, the shifted image 510-1 can be regarded as a shifted and expanded image. In another example, the user may move his/her head down and the angle α may decrease as shown in FIG. 6, and, in Step 210, the processing circuit 110 (more particularly, the detection module 112) may detect that the user moves his/her head down. As a result, in Step 220, the processing circuit 110 (more particularly, the adjustment module 114) may adjust the 2D image by expanding at least one portion (e.g. a portion or all) of the 2D image with the associated image center being shifted upward to generate the shifted image 510-2 (with expansion) for being displayed on the display area. Please note that the shifted image 510-2 may be equivalent to the processing result of generating an expanded version of the 2D image (e.g. the vertically expanded version of the 2D image) and shifting this expanded version of the 2D image upward and further cropping a portion of this expanded version of the 2D image with the display window having the same size as that of the 2D image. As the shifted image 510-2 may be generated by expanding the at least one portion of the 2D image with the associated image center being shifted, the shifted image 510-2 can be regarded as a shifted and expanded image.

In a situation such as that the display module is installed on the wall and the user is standing or walking around, as shown in any of FIGS. 7-8, the user may feel that the 2D image looks like the squeezed image 530 (e.g. a horizontally squeezed image). In the embodiments respectively shown in FIG. 7 and FIG. 8, the forehead orientation may be indicated by the angle β between the line 581-1 and the body axis 592. For example, the user may move his/her head left and the angle β may decrease as shown in FIG. 7, and, in Step 210, the processing circuit 110 (more particularly, the detection module 112) may detect that the user moves his/her head left. As a result, in Step 220, the processing circuit 110 (more particularly, the adjustment module 114) may adjust the 2D image by expanding at least one portion (e.g. a portion or all) of the 2D image with the associated image center being shifted rightward to generate the shifted image 510-3 (with expansion) for being displayed on the display area. Please note that the shifted image 510-3 may be equivalent to the processing result of generating an expanded version of the 2D image (e.g. a horizontally expanded version of the 2D image) and shifting this expanded version of the 2D image rightward and further cropping a portion of this expanded version of the 2D image with a display window having the same size as that of the 2D image. As the shifted image 510-3 may be generated by expanding the at least one portion of the 2D image with the associated image center being shifted, the shifted image 510-3 can be regarded as a shifted and expanded image. In another example, the user may move his/her head right and the angle β may increase as shown in FIG. 8, and, in Step 210, the processing circuit 110 (more particularly, the detection module 112) may detect that the user moves his/her head right. As a result, in Step 220, the processing circuit 110 (more particularly, the adjustment module 114) may adjust the 2D image by expanding at least one portion (e.g. a portion or all) of the 2D image with the associated image center being shifted leftward to generate the shifted image 510-4 (with expansion) for being displayed on the display area. Please note that the shifted image 510-4 may be equivalent to the processing result of generating an expanded version of the 2D image (e.g. the horizontally expanded version of the 2D image) and shifting this expanded version of the 2D image leftward and further cropping a portion of this expanded version of the 2D image with the display window having the same size as that of the 2D image. As the shifted image 510-4 may be generated by expanding the at least one portion of the 2D image with the associated image center being shifted, the shifted image 510-4 can be regarded as a shifted and expanded image.

According to some embodiments, corresponding to an adjustment of the aforementioned at least one portion of the plurality of display contents, the processing circuit 110 (e.g. the adjustment module 114 thereof) may adjust a size and/or a location of a user gesture detection region of a predetermined user gesture, where the user gesture detection region is utilized for detecting whether a user gesture of the user matches the predetermined user gesture. In a situation where the tablet 400 is taken as an example of the electronic device, when the adjustment of Step 220 is applied to the aforementioned at least one portion of the plurality of display contents, the sizes and/or the locations of some video objects on the display region 405A may change correspondingly. By adjusting the size and/or the location of the user gesture detection region corresponding to the adjustment, the processing circuit 110 may make touch-control characteristics match the video objects on the display region 405A, to allow the user to correctly control the tablet 400 with the predetermined user gesture as usual.

According to some embodiments, the operation(s) performed by the processing circuit 110 may switch between a plurality of users of the electronic device. For example, the operations of Step 210 and Step 220 may be performed for the user during a first period, and when Step 210 is re-entered, the operations of Step 210 and Step 220 may be performed for one of other user(s) within the plurality of users during a second period. For example, in Step 210, the processing circuit 110 (more particularly, the detection module 112) may detect a user activity of another user (e.g. the aforementioned one of the other user(s) within the plurality of users) to determine a user orientation of the other user with respect to the display area of the electronic device. In addition, in Step 220, according to the user orientation of the other user with respect to the display area, the processing circuit 110 (more particularly, the adjustment module 114) may selectively adjust at least one portion of the plurality of display contents in the display area to emulate what is viewed from the normal direction of the display area, to allow the other user to view the at least one portion of the plurality of display contents without need of changing the display area orientation of the display area.

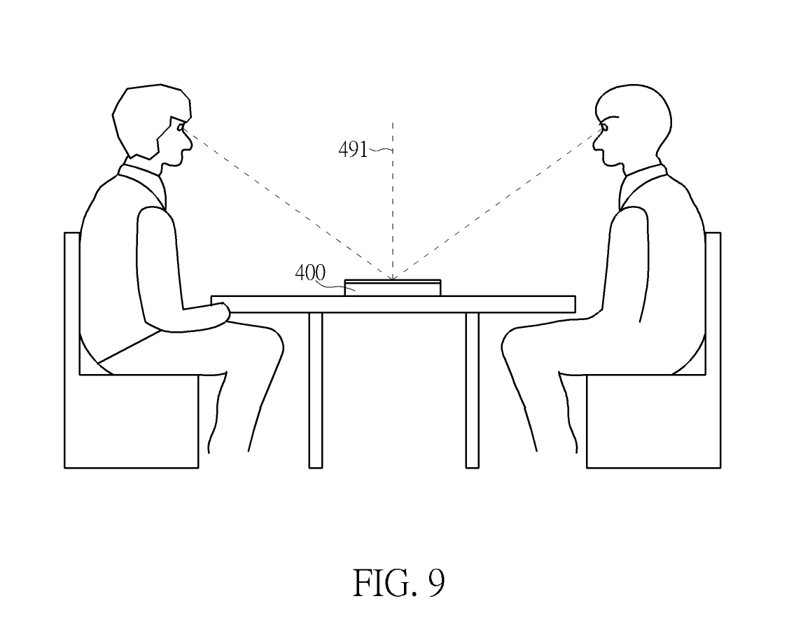

FIG. 9 illustrates a multi-user control scheme involved with the method 200 shown in FIG. 2 according to an embodiment of the present invention. Similarly, the tablet 400 can be taken as an example of the electronic device. In addition, the two persons shown in FIG. 9 can be taken as an example of the plurality of users. For example, the operations of Step 210 and Step 220 may be performed for one of the two persons shown in FIG. 9 during the first period, and when Step 210 is re-entered, the operations of Step 210 and Step 220 may be performed for the other of the two persons shown in FIG. 9 during the second period. For brevity, similar descriptions for this embodiment are not repeated in detail here.

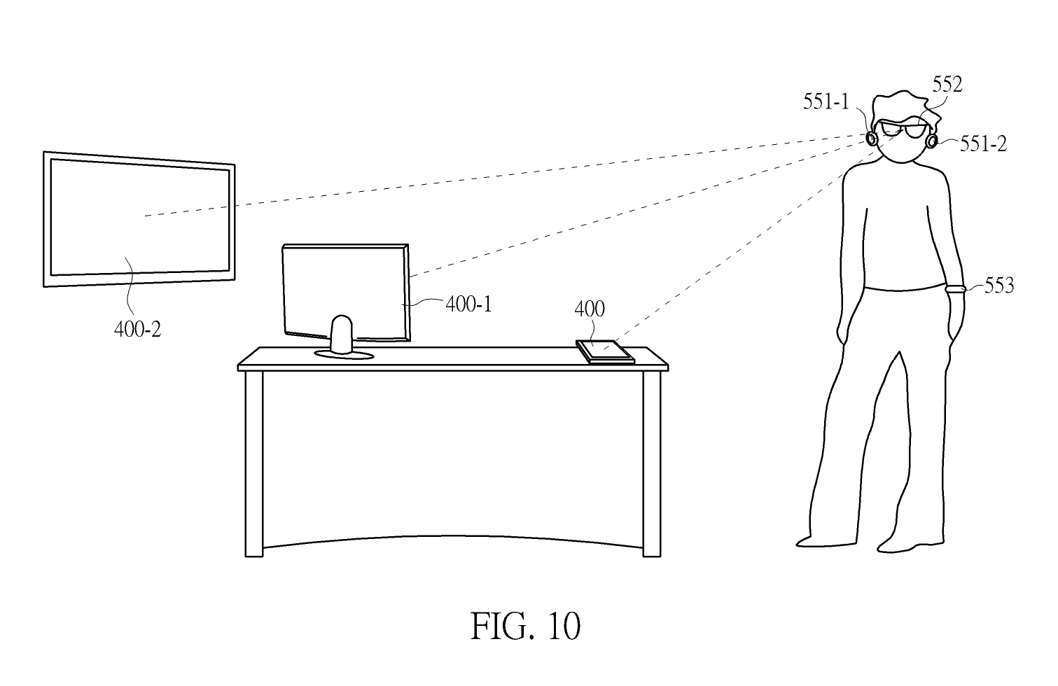

FIG. 10 illustrates a multi-device control scheme involved with the method 200 shown in FIG. 2 according to an embodiment of the present invention. Similarly, the tablet 400 can be taken as an example of the electronic device. In addition, a monitor 400-1 can also be taken as an example of the electronic device. Additionally, a television (TV) 400-2 can also be taken as an example of the electronic device. Thus, each of the tablet 400, the monitor 400-1, and the TV 400-2 may be implemented to have the architecture shown in FIG. 1. For example, the operations of Step 210 and Step 220 may be performed for multiple electronic devices such as the tablet 400, the monitor 400-1, and the TV 400-2, respectively. In another embodiment, two or more of the electronic devices (e.g. two or more of the tablet 400, the monitor 400-1 and the TV 400-2) may be controlled by the same processing circuit 110, so that the detection module 112 may detect a user activity of a user to determine user orientations of the user with respect to the display areas of the two or more electronic devices and the adjustment module 114 may selectively adjust at least one portion of a plurality of display contents in the display areas to emulate what are viewed from normal directions of the display areas according to the user orientations of the user with respect to the display areas.

According to the embodiment shown in FIG. 10, for any of the multiple electronic devices that have been implemented to have the architecture shown in FIG. 1, in Step 210, the processing circuit 110 (more particularly, the detection module 112) may perform the location detection on the user according to the location information of the aforementioned portable or wearable device, to determine the user orientation of the user with respect to the display area of the electronic device. Examples of the portable or wearable device may include, but not limited to, the earphones 551-1 and 551-2, the glasses 552, and the watch 553 shown in FIG. 10. For brevity, similar descriptions for this embodiment are not repeated in detail here.

According to some embodiments, the display area may comprise the aforementioned display region of the display module, such as the display region 305A of the embodiment shown in FIG. 3 or the display region 405A of the embodiment shown in FIG. 4. For example, the electronic device may be a wearable device such as a watch, and the display region of the display module integrated into this wearable device may display the adjustment result of the adjustment of Step 220. For brevity, similar descriptions for these embodiments are not repeated in detail here.

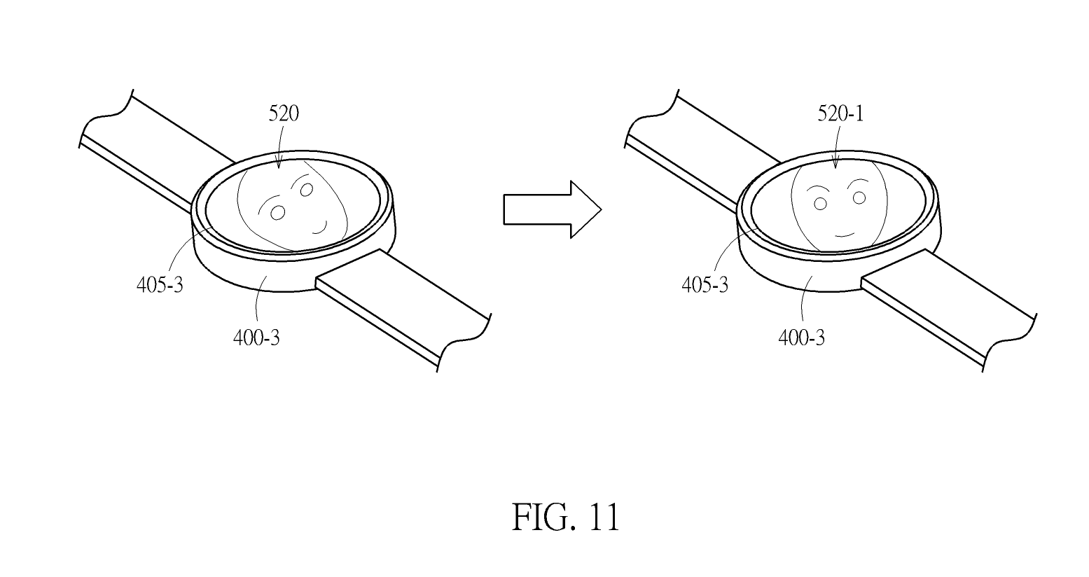

FIG. 11 illustrates a wearable device control scheme involved with the method 200 shown in FIG. 2 according to an embodiment of the present invention. Similarly, the watch 400-3 can be taken as an example of the electronic device. Suppose that the display module 405-3 of the watch 400-3 can be utilized for displaying time, and can also be utilized for displaying other information. For example, the user may find that the original image 520 having the face of somebody, such as the face of the other person in a video call (e.g. an one-to-one, live, video conversation over a network or the Internet), seems to have been squeezed before the operation of Step 220 is performed, where the original image 520 can be taken as an example of the image comprising the plurality of display contents mentioned in Step 220. After the operation of Step 220 is performed, the image comprising the plurality of display contents (e.g. the original image 520) has been adjusted so that the user may view the adjusted image 520-1 easily and clearly, and the user may find nothing in the adjusted image 520-1 being squeezed, as if the display module 405-3 of the watch 400-3 had been rotated to make the normal vector of the display area mentioned in Step 210 (e.g. the normal vector of the display region of the display module 405-3) be directed to the eyes of the user. For brevity, similar descriptions for these embodiments are not repeated in detail here.

According to some embodiments, the processing circuit 110 (e.g. the detection module 112 thereof) may detect a majority group of users within a plurality of users (such as the plurality of users mentioned in some embodiments described above) to determine a user orientation of the majority group of users with respect to the display area of the electronic device, where the majority group of users may comprises the user mentioned above. In addition, according to the user orientation of the majority group of users with respect to the display area, the processing circuit 110 (e.g. the adjustment module 114 thereof) may selectively adjust at least one portion of the plurality of display contents in the display area to emulate what is viewed from the normal direction of the display area, to allow the majority group of users to view the at least one portion of the plurality of display contents without need of changing the display area orientation of the display area. For brevity, similar descriptions for these embodiments are not repeated in detail here.

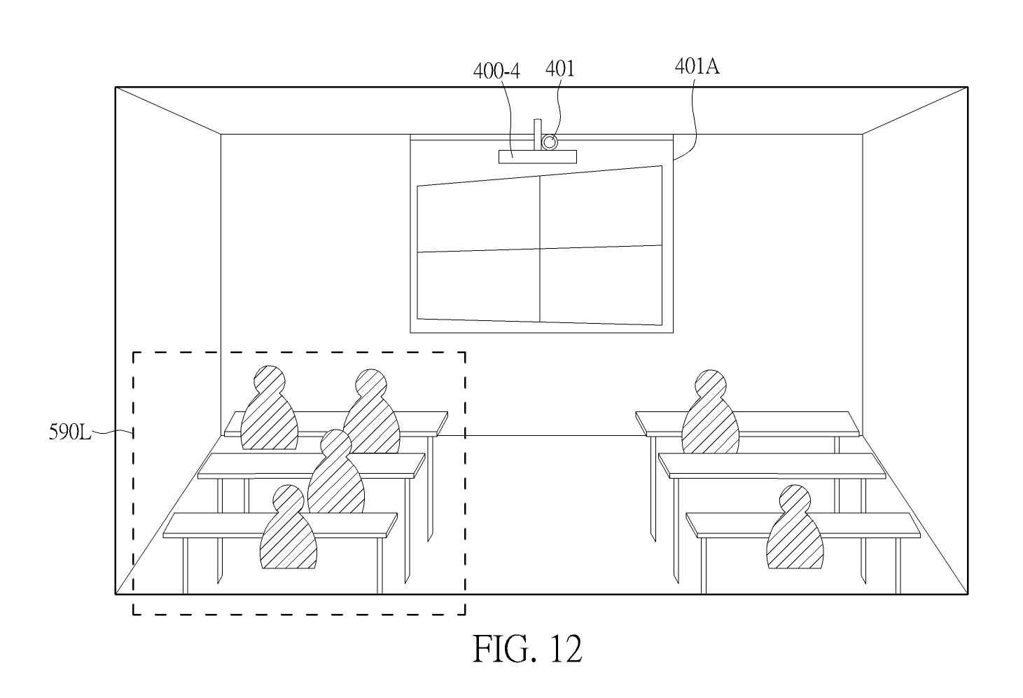

FIG. 12 illustrates a left configuration of a majority group control scheme involved with the method 200 shown in FIG. 2 according to an embodiment of the present invention, where a video system 400-4 can be taken as an example of the electronic device. For example, the video system 400-4 may comprise a projector for projecting images on a screen, and may comprise a camera 401 for capturing images of the users such as the attendants of a meeting in the meeting room. In addition, the camera 401 may be installed on the top of the screen. This is for illustrative purposes only, and is not meant to be a limitation of the present invention. According to some embodiments, both of the camera 401 and the processing circuit 110 may be integrated into the projector. According to some embodiments, the projector may be positioned outside the video system 400-4, and the processing circuit 110 may be integrated into the camera 401 of the video system 400-4. According to some embodiments, the video system 400-4 may be implemented as a monitor equipped with the camera 401, and the processing circuit 110 may be integrated into the monitor. According to some embodiments, the video system 400-4 may be implemented as a video control device outside the projector and the camera 401, and the processing circuit 110 may be integrated into the video control device.

As shown in FIG. 12, the processing circuit 110 (e.g. the detection module 112 thereof) may detect the majority group of users with aid of the camera 401, to determine the user orientation of the majority group of users with respect to the display area 401A of the video system 400-4, such as the orientation of the attendants 590L of the meeting that are sitting at the left side of the meeting room. As a result, the processing circuit 110 (e.g. the adjustment module 114 thereof) may selectively adjust at least one portion of the display contents in the display area 401A to emulate what is viewed from the normal direction of the display area 401A, to allow the majority group of users (e.g. the attendants 590L sitting at the left side in this embodiment) to view the at least one portion of the display contents without need of changing the display area orientation of the display area 401A. For brevity, similar descriptions for these embodiments are not repeated in detail here.

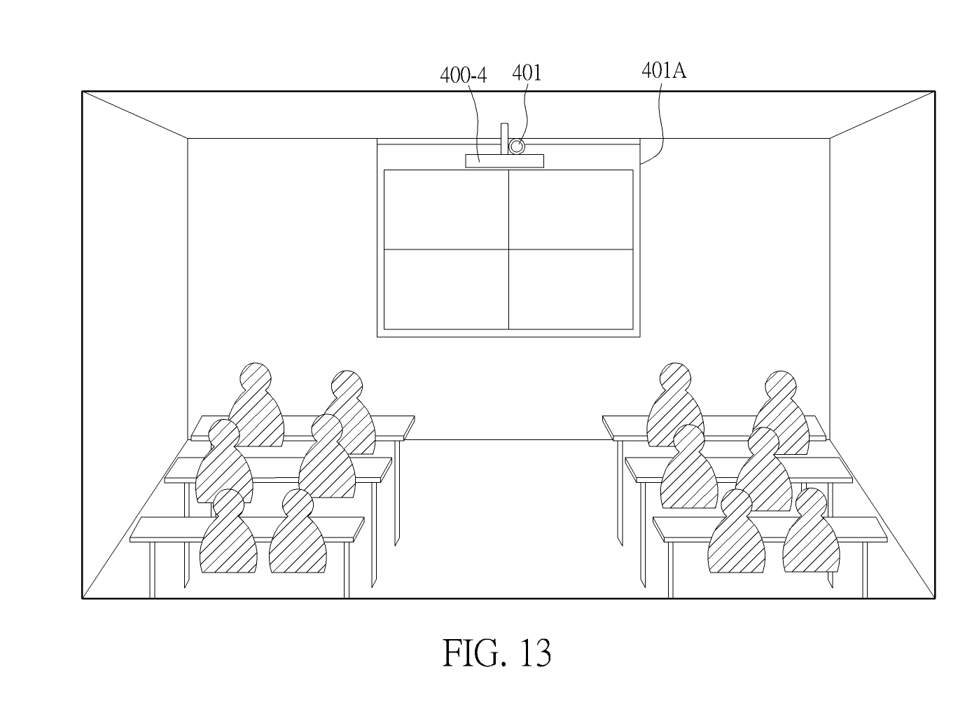

FIG. 13 illustrates a normal configuration of the majority group control scheme involved with the method 200 shown in FIG. 2 according to an embodiment of the present invention. As shown in FIG. 13, the processing circuit 110 (e.g. the detection module 112 thereof) may detect the majority group of users with aid of the camera 401, to determine the user orientation of the majority group of users with respect to the display area 401A of the video system 400-4, such as the orientation of all of the attendants of the meeting. For example, the number of attendants that are sitting at the left side of the meeting room may be equivalent or approximately equivalent to the number of attendants that are sitting at the right side of the meeting room, and the processing circuit 110 (e.g. the detection module 112 thereof) may determine that the majority group of users comprise both of those sitting at the left side of the meeting room and those sitting at the right side of the meeting room. As a result, the processing circuit 110 (e.g. the adjustment module 114 thereof) may prevent adjusting the display contents in the display area 401A since emulating what is viewed from the normal direction of the display area 401A for only those sitting at the left side of the meeting room or for only those sitting at the right side of the meeting room is not needed. For brevity, similar descriptions for these embodiments are not repeated in detail here.

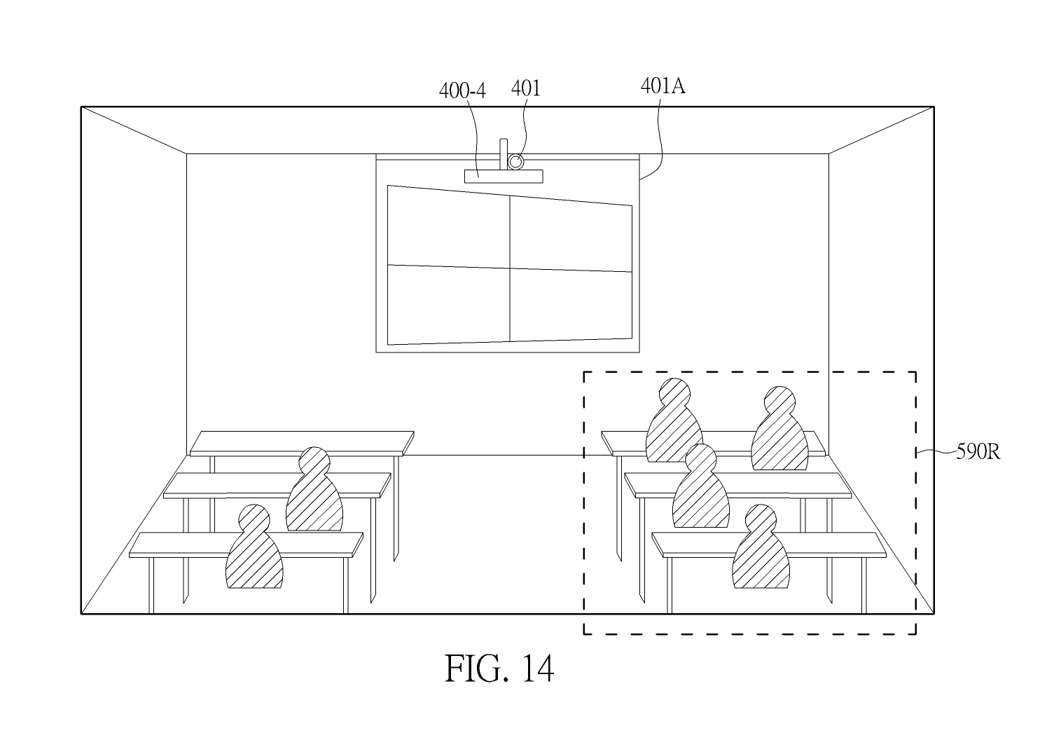

FIG. 14 illustrates a right configuration of the majority group control scheme involved with the method 200 shown in FIG. 2 according to an embodiment of the present invention. As shown in FIG. 14, the processing circuit 110 (e.g. the detection module 112 thereof) may detect the majority group of users with aid of the camera 401, to determine the user orientation of the majority group of users with respect to the display area 401A of the video system 400-4, such as the orientation of the attendants 590R of the meeting that are sitting at the right side of the meeting room. As a result, the processing circuit 110 (e.g. the adjustment module 114 thereof) may selectively adjust at least one portion of the display contents in the display area 401A to emulate what is viewed from the normal direction of the display area 401A, to allow the majority group of users (e.g. the attendants 590R sitting at the left side in this embodiment) to view the at least one portion of the display contents without need of changing the display area orientation of the display area 401A. For brevity, similar descriptions for these embodiments are not repeated in detail here.

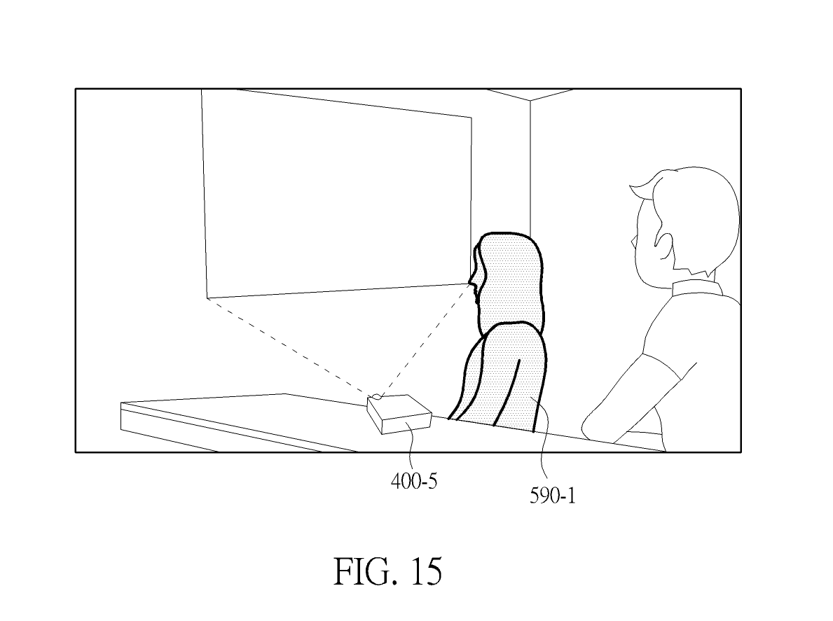

FIG. 15 illustrates a first configuration of a dynamic control scheme involved with the method 200 shown in FIG. 2 according to an embodiment of the present invention, where a video system 400-5 can be taken as an example of the electronic device. For example, the video system 400-5 may comprise a projector for projecting images on a white or gray wall or a screen, and may comprise a set of microphones for the attendants of a meeting in the meeting room, respectively. In addition, the locations of the set of microphones may be fixed and may be predetermined, and the processing circuit 110 (e.g. the detection module 112 thereof) may determine the user orientation mentioned in Step 210 with aid of one of the set of microphones, such as that used by the user mentioned in Step 210 (e.g. one of the attendants in this embodiment). For example, when Step 210 is entered, the operation of Step 210 may be performed for detecting the latest condition such as the latest user orientation of any of the other users (e.g. another of the attendants in this embodiment) with respect to the display area, and the operation of Step 220 may be performed in response to the latest condition mentioned above. This is for illustrative purposes only, and is not meant to be a limitation of the present invention. According to some embodiments, the set of microphones may be implemented as wireless microphones, and the video system 400-5 may comprise a wireless communication module (e.g. a BT transceiver, a Wi-Fi transceiver, etc.), where each of these wireless microphones may provide the video system 400-5 with location information such as that of the aforementioned portable or wearable device.

As shown in FIG. 15, the processing circuit 110 (e.g. the detection module 112 thereof) may detect that the attendant 590-1 is speaking, and then determine the user orientation of the attendant 590-1 with respect to the display area mentioned in Step 210. As a result, the processing circuit 110 (e.g. the adjustment module 114) may adjust at least one portion (e.g. one or more portions) of the display contents in the display area of this embodiment to emulate what is viewed from the normal direction of the display area, to allow the attendant 590-1 to view the at least one portion of the display contents without need of changing the display area orientation of the display area (such as that on the white or gray wall or on the screen). For brevity, similar descriptions for these embodiments are not repeated in detail here.

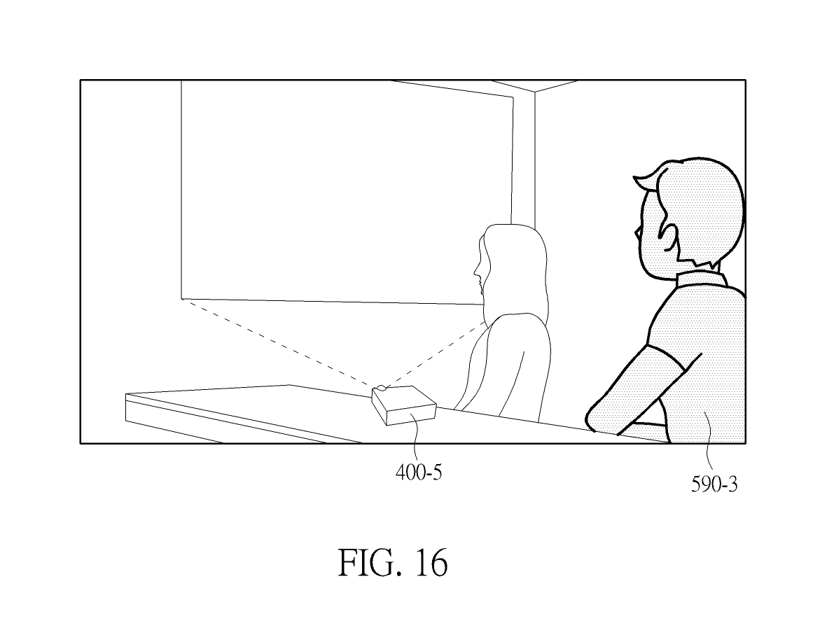

FIG. 16 illustrates a second configuration of the dynamic control scheme involved with the method 200 shown in FIG. 2 according to an embodiment of the present invention. As shown in FIG. 16, the processing circuit 110 (e.g. the detection module 112 thereof) may detect that the attendant 590-3 is speaking, and then determine the user orientation of the attendant 590-3 with respect to the display area mentioned in Step 210. As a result, the processing circuit 110 (e.g. the adjustment module 114) may adjust at least one portion (e.g. one or more portions) of the display contents in the display area of this embodiment to emulate what is viewed from the normal direction of the display area, to allow the attendant 590-3 to view the at least one portion of the display contents without need of changing the display area orientation of the display area (such as that on the white or gray wall or on the screen). For brevity, similar descriptions for these embodiments are not repeated in detail here.

According to some embodiments, the display area may comprise a first partial region of the display region on the display module of the electronic device, and the user activity may comprise changing a shape of the display module. For example, the display module may be a flexible or bendable display module. In addition, according to the user orientation of the user with respect to the display area, the processing circuit 110 (e.g. the adjustment module 114 thereof) may adjust display contents in other partial regions of the display region to emulate what is viewed from the normal direction of the display area with a planar configuration of the display module, to allow the user to view the display contents in the other partial regions without need of recovering the shape of the display module. As a result, the user may clearly view the display contents and/or may clearly read the texts. For brevity, similar descriptions for these embodiments are not repeated in detail here.

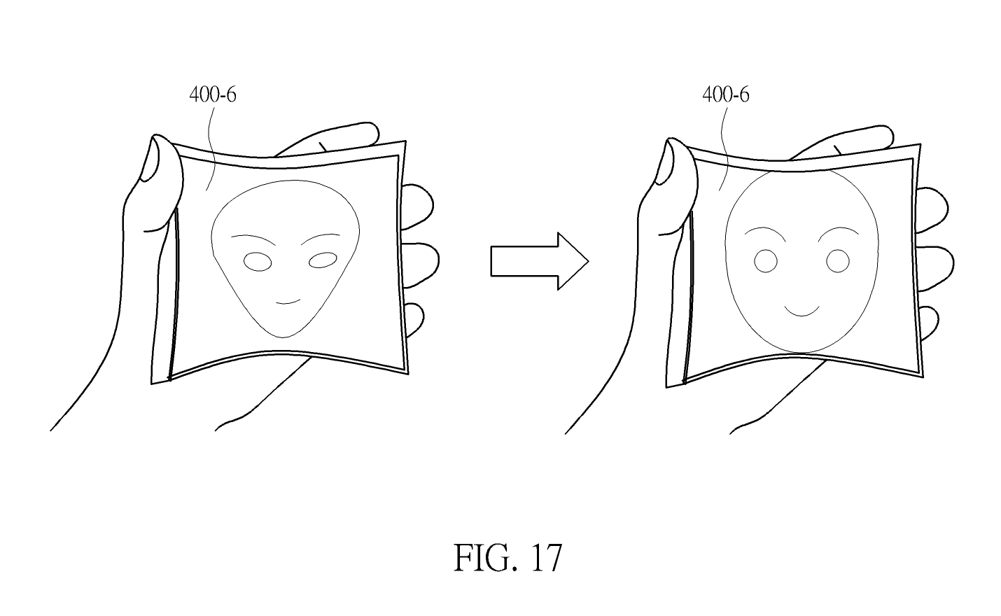

FIG. 17 illustrates a flexible display control scheme involved with the method 200 shown in FIG. 2 according to an embodiment of the present invention. For example, the display module may be the aforementioned flexible or bendable display module such as a flexible display device 400-6. As shown in the left half of FIG. 17, the original image on the flexible display device 400-6 seems to have been squeezed. For example, the first partial region mentioned above can be a central region of the flexible display device 400-6. As shown in the right half of FIG. 17, according to the user orientation of the user with respect to the display area such as the central region of the flexible display device 400-6, the processing circuit 110 (e.g. the adjustment module 114 thereof) may adjust the display contents in the other partial regions of the display region to emulate what is viewed from the normal direction of the display area with the planar configuration of the flexible display device 400-6 (as if the flexible display device 400-6 was not bended), to allow the user to view the display contents in the other partial regions without need of recovering the shape of the display module. As a result, the user may clearly view the display contents. For brevity, similar descriptions for this embodiment are not repeated in detail here.

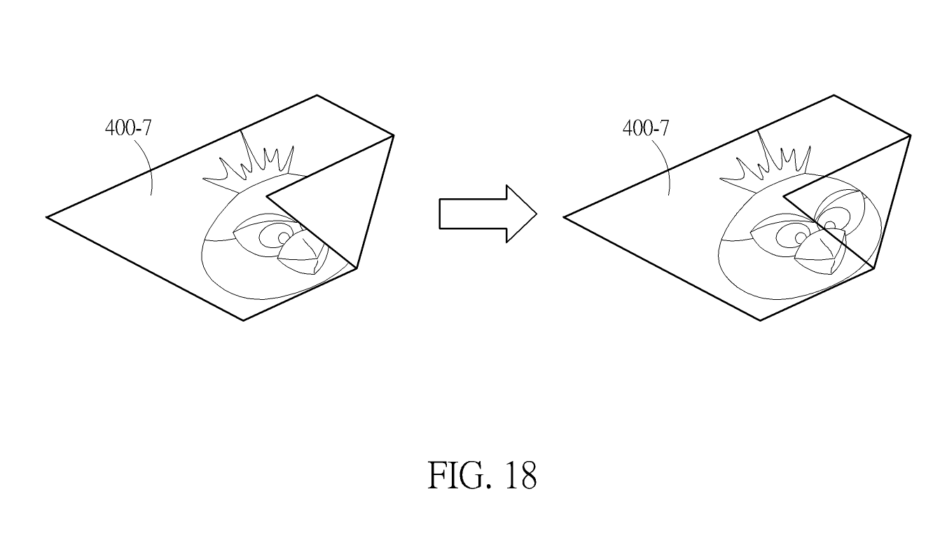

FIG. 18 illustrates a flexible display control scheme involved with the method 200 shown in FIG. 2 according to another embodiment of the present invention. For example, the display module may be the aforementioned flexible or bendable display module such as a foldable display device 400-7. As shown in the left half of FIG. 18, a portion of the original image is missing since a corner of the foldable display device 400-7 has been bent over. For example, the first partial region mentioned above can be a central region of the foldable display device 400-7. As shown in the right half of FIG. 18, according to the user orientation of the user with respect to the display area such as the central region of the foldable display device 400-7, the processing circuit 110 (e.g. the adjustment module 114 thereof) may adjust the display contents in the other partial regions of the display region, such as that on the back of the bent corner of the foldable display device 400-7, to emulate what is viewed from the normal direction of the display area with the planar configuration of the foldable display device 400-7 (as if the corner of the foldable display device 400-7 was not bent), to allow the user to view the display contents in the other partial regions without need of recovering the shape of the display module. As a result, the user may clearly view the display contents. For brevity, similar descriptions for this embodiment are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing display control of an electronic device, the method comprising the steps of:
detecting a user activity of a user to determine a user orientation of the user with respect to a display area of the electronic device; and
according to the user orientation of the user with respect to the display area, selectively adjusting at least one portion of a plurality of display contents in the display area to emulate what is viewed from a normal direction of the display area, to allow the user to view the at least one portion of the plurality of display contents without need of changing a display area orientation of the display area.

2. The method of claim 1, wherein the normal direction is a direction along a virtual line perpendicular to the display area.

3. The method of claim 1, wherein the step of detecting the user activity of the user to determine the user orientation of the user with respect to the display area of the electronic device further comprises:
detecting at least one face image of the user to determine the user orientation of the user with respect to the display area of the electronic device, wherein the at least one face image indicates the user activity.

4. The method of claim 1, wherein the step of detecting the user activity of the user to determine the user orientation of the user with respect to the display area of the electronic device further comprises:
performing infrared (IR) detection on the user to determine the user orientation of the user with respect to the display area of the electronic device, wherein at least one IR detection result of the IR detection indicates the user activity.

5. The method of claim 1, wherein the step of detecting the user activity of the user to determine the user orientation of the user with respect to the display area of the electronic device further comprises:
performing acoustic detection on the user to determine the user orientation of the user with respect to the display area of the electronic device, wherein at least one acoustic detection result of the acoustic detection indicates the user activity.

6. The method of claim 1, wherein the step of detecting the user activity of the user to determine the user orientation of the user with respect to the display area of the electronic device further comprises:
performing location detection on the user according to location information of a portable or wearable device of the user, to determine the user orientation of the user with respect to the display area of the electronic device, wherein at least one location detection result of the location detection indicates the user activity.

7. The method of claim 1, wherein the step of adjusting the at least one portion of the plurality of display contents in the display area to emulate what is viewed from the normal direction of the display area to allow the user to view the at least one portion of the plurality of display contents without need of changing the display area orientation of the display area further comprises:
expanding the at least one portion of the plurality of display contents.

8. The method of claim 1, wherein the at least one portion of the plurality of display contents comprises different portions of the plurality of display contents; and the step of adjusting the at least one portion of the plurality of display contents in the display area to emulate what is viewed from the normal direction of the display area to allow the user to view the at least one portion of the plurality of display contents without need of changing the display area orientation of the display area further comprises:
scaling up or down the portions of the plurality of display contents with different size-adjustment ratios, respectively.

9. The method of claim 1, wherein the step of adjusting the at least one portion of the plurality of display contents in the display area to emulate what is viewed from the normal direction of the display area to allow the user to view the at least one portion of the plurality of display contents without need of changing the display area orientation of the display area further comprises:
brightening the at least one portion of the plurality of display contents.

10. The method of claim 1, wherein the at least one portion of the plurality of display contents comprises different portions of the plurality of display contents; and the step of adjusting the at least one portion of the plurality of display contents in the display area to emulate what is viewed from the normal direction of the display area to allow the user to view the at least one portion of the plurality of display contents without need of changing the display area orientation of the display area further comprises:
adjusting brightness of the portions of the plurality of display contents with different brightness-adjustment ratios, respectively.

11. The method of claim 10, wherein a first portion within the portions of the plurality of display contents is closer to the user than a second portion within the portions of the plurality of display contents; and a first brightness-adjustment ratio corresponding to the first portion is less than a second brightness-adjustment ratio corresponding to the second portion.

12. The method of claim 1, further comprising:
when the user orientation of the user with respect to the display area falls outside a predetermined range, triggering adjusting the at least one portion of the plurality of display contents in the display area; and
when the user orientation of the user with respect to the display area falls within the predetermined range, cancelling adjusting the at least one portion of the plurality of display contents in the display area.

13. The method of claim 1, wherein the step of adjusting the at least one portion of the plurality of display contents in the display area to emulate what is viewed from the normal direction of the display area to allow the user to view the at least one portion of the plurality of display contents without need of changing the display area orientation of the display area further comprises:
adjusting an image orientation of a two-dimensional (2D) image within the display area, wherein the 2D image comprises the at least one portion of the plurality of display contents.

14. The method of claim 1, wherein the step of detecting the user activity of the user to determine the user orientation of the user with respect to the display area of the electronic device further comprises:
detecting the user activity of the user to determine a forehead orientation of the user with respect to at least one body axis of the user;
wherein the method further comprises:
shifting a two-dimensional (2D) image within the display area, wherein the 2D image comprises the at least one portion of the plurality of display contents.

15. The method of claim 1, further comprising:
adjusting a size and/or a location of a user gesture detection region of a predetermined user gesture in response to an adjustment result of the at least one portion of the plurality of display contents, wherein the user gesture detection region is utilized for detecting whether a user gesture of the user matches the predetermined user gesture.

16. The method of claim 1, further comprising:
detecting a user activity of another user to determine a user orientation of the other user with respect to the display area of the electronic device; and
according to the user orientation of the other user with respect to the display area, selectively adjusting at least one portion of the plurality of display contents in the display area to emulate what is viewed from the normal direction of the display area, to allow the other user to view the at least one portion of the plurality of display contents without need of changing the display area orientation of the display area.

17. The method of claim 1, wherein the display area comprises a display region on a display module of the electronic device, and the electronic device is a wearable device.

18. The method of claim 1, further comprising:
detecting a majority group of users within a plurality of users to determine a user orientation of the majority group of users with respect to the display area of the electronic device, wherein the majority group of users comprises the user; and
according to the user orientation of the majority group of users with respect to the display area, selectively adjusting at least one portion of the plurality of display contents in the display area to emulate what is viewed from the normal direction of the display area, to allow the majority group of users to view the at least one portion of the plurality of display contents without need of changing the display area orientation of the display area.

19. The method of claim 1, wherein the display area comprises a first partial region of a display region on a display module of the electronic device, and the user activity comprises changing a shape of the display module; and the method further comprises:
according to the user orientation of the user with respect to the display area, adjusting display contents in other partial regions of the display region to emulate what is viewed from the normal direction of the display area with a planar configuration of the display module, to allow the user to view the display contents in the other partial regions without need of recovering the shape of the display module.

20. An apparatus for performing display control of an electronic device, the apparatus comprising:
a processing circuit, positioned in the electronic device, wherein the processing circuit comprises:
a detection module, arranged for detecting a user activity of a user to determine a user orientation of the user with respect to a display area of the electronic device; and
an adjustment module, wherein according to the user orientation of the user with respect to the display area, the adjustment module selectively adjusts at least one portion of a plurality of display contents in the display area to emulate what is viewed from a normal direction of the display area, to allow the user to view the at least one portion of the plurality of display contents without need of changing a display area orientation of the display area.
